(19) United States
(12) Patent Application Publication
(10) Pub. No.: US 2006/0033229 A1
(43) Pub. Date: Feb. 16, 2006

(54) Pumice stones and methods for making them

(76) Inventor: Scott G. Daley, Ojai, CA (US)

Correspondence Address: COHEN SAKAGUCHI & ENGLISH LLP, 2040 MAIN STREET, 9TH FLOOR, IRVINE, CA, 92614, US

(21) Appl. No.: 10/901,488

(22) Filed: Jul. 27, 2004

(51) Int. Cl. B29C 41/22; C09K 3/14; B27N 3/00

(52) U.S. Cl. 264/109; 51/298; 264/73

(57) ABSTRACT

Pumice stones are provided that includes abrasive material including a blend of abrasives, binder material to hold the abrasive material in a three-dimensional shape, e.g., an organic shape, and pigment to provide a desired decorative pattern. The pigment may be embedded within the pumice stone and/or applied to exposed surfaces thereof. The pumice stone may include different abrasive grits on different surfaces and/or may include inlaid elements in one or more surfaces. Optionally the abrasive and binder materials may be synthetic materials, e.g., aluminum oxide and/or acrylic abrasives, and/or may be transparent or translucent to enhance color resolution of pigment embedded within or applied to surfaces of the pumice stone. Methods for making such pumice stones are also disclosed.

### FIELD OF INVENTION

The present invention relates generally to abrasive articles, e.g., for personal use, and, more particularly, to pumice stones that may include natural and/or artificial materials.

### BACKGROUND

Pumice stones generally include pieces of natural pumice that are cut from large chunks of mined pumice, e.g., into desired geometric shapes, such as rectangular shapes. In addition, pumice may be ground into powder and formed into sheets, e.g., using a binder, and cut or stamped into individual pumice stones. It has also been suggested to make “pumice” stones including ceramic materials, e.g., clay and the like, that may be formed into sheets, fired using conventional methods, and stamped or cut into individual pumice stones.

One of the disadvantages of natural or ceramic pumice stones is that the material may be brittle, i.e., may chip or break easily, e.g., if dropped. In addition, because natural pumice and ceramic materials are opaque, attempts to add color to improve the aesthetics of the finished product generally results in dull appearance and/or poor color resolution.

### SUMMARY OF THE INVENTION

The present invention is directed generally to pumice stones or other abrasive objects, e.g., for personal use, formed from natural and/or synthetic abrasive materials, and to methods for making such pumice stones. As used herein, “synthetic” abrasives shall refer to any abrasive materials that are not natural pumice, and “pumice stone” shall refer to an abrasive article that includes natural pumice and/or synthetic abrasives.

In one embodiment, a pumice stone is provided that includes abrasive material including a blend of abrasives, binder material to hold the abrasive material in a predetermined three-dimensional shape, and pigment applied to at least one of the abrasive material and the binder material to provide a desired decorative pattern. The pigment may be applied to the one or more exposed surfaces to provide the desired decorative pattern, and/or may be embedded within the pumice stone.

Optionally, the pumice stone may include a hollow core or a core material, e.g., foam, surrounded by the abrasive and binder materials. In a further option, the pumice stone may include a handle member partially embedded within, attached to, or otherwise extending from the pumice stone.

In one embodiment, the predetermined shape is an organic shape, although alternatively the predetermined shape may be a geometric shape. In addition, the pumice stone may include at least first and second exposed surfaces, and the blend of the abrasive material may provide different grits on the first and second exposed surfaces.

Optionally, the abrasive material may include substantially transparent or translucent abrasives, such as a blend of aluminum oxide, plastic, and/or glass. In addition, the binder material may also be substantially transparent or translucent. Such materials may enhance color resolution of one or more pigments applied to the pumice stone, particularly dyes, colored mineral powders, glitter, pearlessence, and/or meltable pigments that are embedded within the pumice stone, e.g., mixed with the abrasive material and/or binder material.

In another embodiment, a pumice stone is provided that includes abrasive material including nut shells, fruit pits, or other natural materials that are ground up or otherwise provided in abrasive grains or particles, and binder material to hold the abrasive material in a predetermined three-dimensional shape, e.g., linseed oil and/or rapeseed oil.

In yet another embodiment, a pumice stone is provided that includes a first layer including a mixture of abrasive material and binder material having a first abrasive grit; and a second layer including a mixture of abrasive material and binder material having a second abrasive grit, the second layer being bonded to the first layer. Optionally, pigment may be applied to one or both of the first and second layers to provide a desired decorative pattern. For example, pigment may be applied to one or more exposed surfaces of the layers to provide the desired decorative pattern and/or pigment may be embedded within at least one of the first and second layers.

In still another embodiment, a pumice stone is provided that includes abrasive material and binder material formed into a three-dimensional shape including at least a first surface, and structures inlaid in the first surface to provide a decorative pattern.

In yet another embodiment, a method is provided for making a pumice stone that includes mixing two or more different abrasives into a blend of abrasive material having a desired abrasive grit, mixing the blend of abrasive material with binder material, and curing the binder material to form a predetermined three-dimensional shape. In one embodiment, the blend of abrasive material and/or the binder material are substantially transparent or translucent, and the binder material is cured without substantially increasing the opacity of the blend of abrasive material and the binder material. Optionally, pigment may be added to the blend of abrasive material and/or the binder material. In addition or alternatively, pigment may be applied to one or more surfaces of the pumice stone after the binder material is cured.

In still another embodiment, a method is provided for making a pumice stone that includes placing a first layer including a first mixture of abrasive material and binder material in a mold, placing a second layer including a second mixture of abrasive material and binder material in the mold, and curing the binder material of the first and second layers to form a three-dimensional pumice stone. The second layer may have a different pigment and/or a different abrasive grit than the first layer.

In one embodiment, two or more abrasives may be blended into a first blend having a first abrasive grit, and the first blend may be mixed with binder material to create the first mixture. Similarly, two or more abrasives may be blended into a second blend having a second abrasive grit different than the first abrasive grit, and the second blend may be mixed with binder material to create the second mixture. The first and second layers may be placed within the mold such that the first layer defines a first exposed surface of the pumice stone, and the second layer defines a second exposed surface of the pumice stone.

In another embodiment, the mold may include one or more interior walls dividing the mold into different regions. The first layer may be placed within at least one region defined by the one or more interior walls, and the second layer may be applied over the first layer such that the second layer extends into one or more other regions defined by the interior wall(s). If the first and second layers include different pigments, when the pumice stone is removed from the mold, the first and second layers may provide different color inlaid elements in a surface of the pumice stone.

Other aspects and features of the present invention will become apparent from consideration of the following description taken in conjunction with the accompanying drawings.

### BRIEF DESCRIPTION OF THE DRAWINGS

FIG. 1 is a perspective view of a first embodiment of a pumice stone shaped in the form of a clam shell.

FIG. 1A is a cross-sectional view of the pumice stone of FIG. 1, taken along line 1A-1A.

FIG. 1B is a cross-sectional view of an alternative embodiment of the pumice stone of FIG. 1, having different abrasives grits on its upper and lower surfaces.

FIG. 1C is a cross-sectional view of another alternative embodiment of the pumice stone of FIG. 1, having an image beneath a substantially transparent or translucent layer.

FIG. 2 is a perspective view of a second embodiment of a pumice stone, including molded-in shapes.

FIG. 2A is a cross-sectional view of the pumice stone of FIG. 2, taken along line 2A-2A, disposed within a mold.

FIG. 3 is a perspective view of a third embodiment of a pumice stone including a handle member.

FIG. 3A is a cross-sectional view of the pumice stone of FIG. 3, taken along line 3A-3A.

### DETAILED DESCRIPTION OF THE PREFERRED EMBODIMENTS

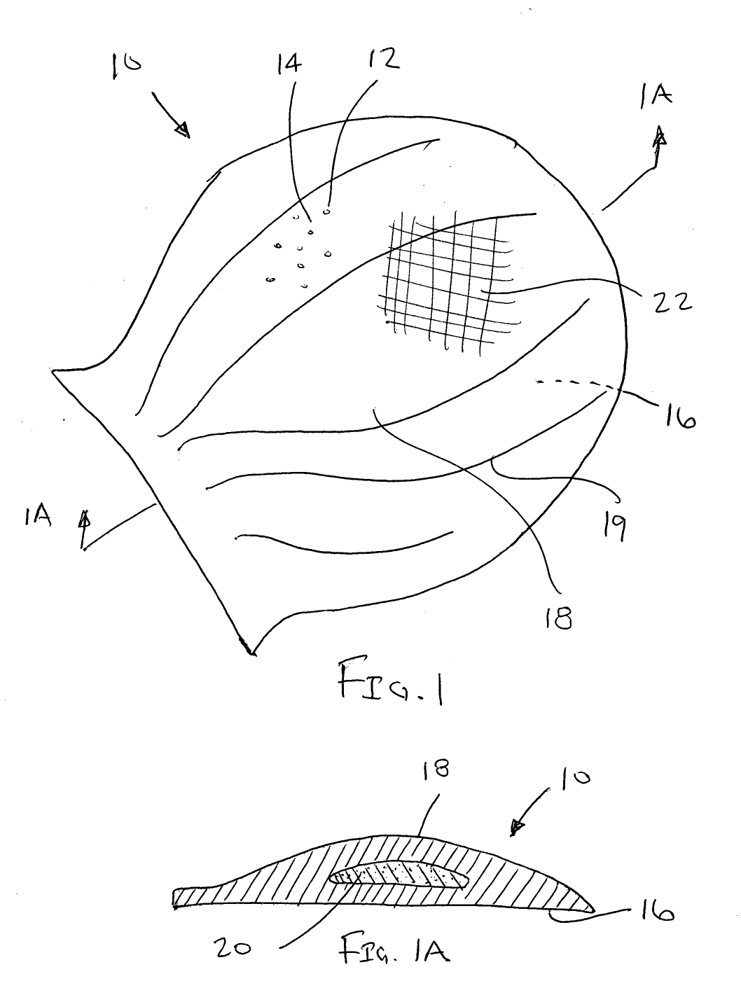

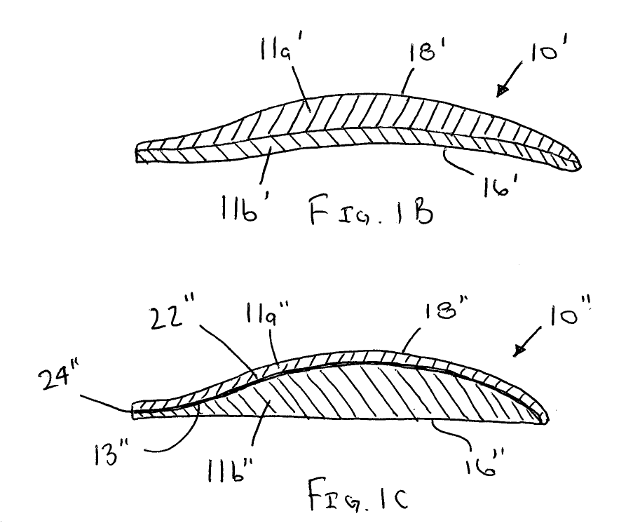

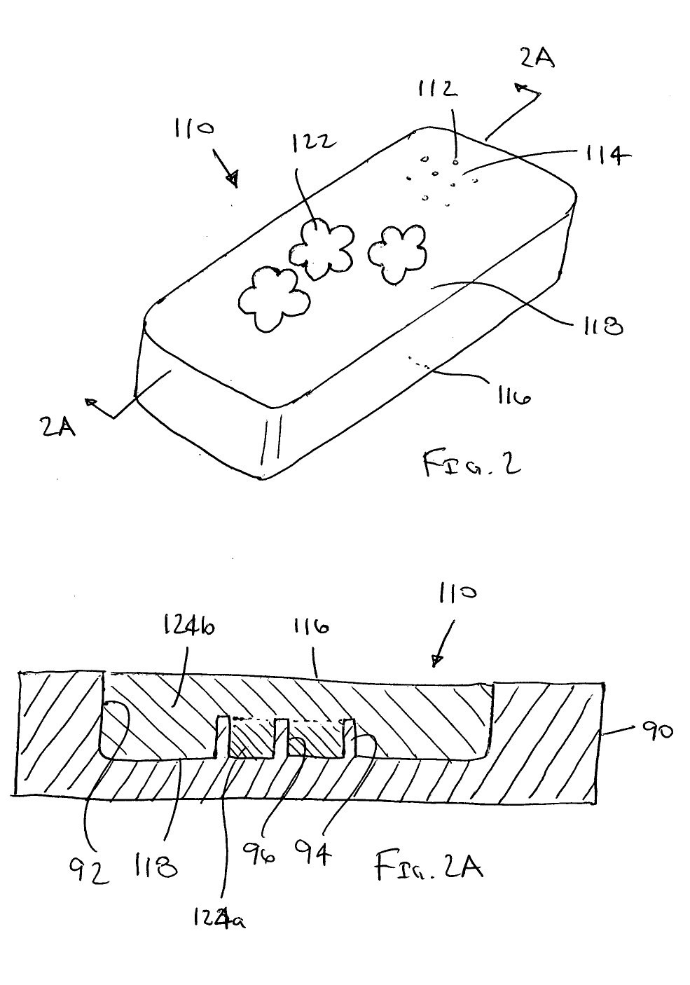

Turning to the drawings, FIG. 1 shows an exemplary embodiment of a pumice stone 10 that generally includes abrasive material, represented by exemplary grains 12, and binder material 14 to hold the abrasive material in a predetermined shape. The pumice stone 10 may include a substantially planar first or lower surface 16 and a nonplanar second or upper surface 18 defining a three-dimensional organic shape. Alternatively, both of the upper and lower surfaces may be substantially planar or nonplanar (not shown), depending upon the desired shape and aesthetic qualities of the finished pumice stone.

In the exemplary embodiment shown in FIG. 1, the pumice stone 10 has an organic shape similar to a clam shell having a convex upper surface 18, e.g., including grooves or scallops 19. The lower surface 16 may be substantially planar, e.g., as shown in FIG. 1A, or may be slightly concave, e.g., as shown in FIG. 1B. Alternatively, the pumice stone may be formed into other three-dimensional and/or organic shapes, such as sea shells; rubber ducks; flowers, leaves, or other plants; butterflies, ladybugs, frogs, or other animals; cinnamon rolls or other food items; icons or alphanumeric symbols; animated, fictional, or nonfictional characters; a pair of lips or other anatomical features; and the like.

In one embodiment, the abrasive material 12 includes a blend of abrasives, e.g., selected to provide desired properties for the finished product. For example, the abrasive material 12 may include one or more of pumice, glass, aluminum oxide, acrylic or other plastic, e.g., ground or otherwise provided in powder, grains, or other particles of a desired size and/or shape, e.g., having a size between about twenty and two hundred eighty (20-280), preferably between about forty and one hundred fifty (40-150) grit. The abrasive material 12 may be mixed together in a predetermined ratio, e.g., into a single substantially uniform blend before being mixed with the binder material. Alternatively, multiple blends may be mixed and provided together and utilized for different portions of the pumice stone 10, as explained further below.

In one embodiment, the abrasive material 12 may include a blend of substantially transparent or translucent material, e.g., aluminum oxide, glass, and/or acrylic abrasive. As explained further below, transparent and/or translucent abrasive may enhance the appearance of pigment or other color added or applied to a pumice stone. In an exemplary embodiment, the abrasive material 12 may include between about forty and sixty percent (40-60%) by weight each of aluminum oxide and acrylic abrasive. Aluminum oxide has a more coarse abrasive grit compared to acrylic, but also has greater density. Thus, to provide a more abrasive pumice stone, the ratio of aluminum oxide to acrylic may be increased, which may increase the overall weight of the pumice stone 10. Optionally, glass may also be included in the blend, e.g., to further enhance the abrasive grit of the pumice stone 10 without adding substantially to the opacity of the abrasive material 12. However, if glass is added, it may be desirable to treat the glass grains, e.g., to reduce the jaggedness or sharpness of the grains to prevent cutting or reduce abrading to a desired grit.

The binder material 14 may include any material capable of retaining the abrasive material 12 in the intended shape for the pumice stone 10, while still providing abrasive surfaces 16, 18 having desired grits. For example, the binder material 14 may include one or more resins, e.g., acrylic, latex, natural or synthetic rubber, polyester, polyvinyl acetate (“PVA”), polyurethane, silicone, phenolic, alkyds, polyamide, epoxy, or other polymers or combinations that may be cured under desired conditions. The binder material 14 may be cured under substantially ambient temperatures and/or pressures, or using increased pressure and/or heat, e.g., to enhance, accelerate, and/or complete curing, as described further below. For example, sufficient pressure may be used to compress the material into the desired shape and/or to substantially fill the cavity of a mold or other tools.

As shown in FIG. 1A, the pumice stone 10 may include a core 20, e.g., foam, cork, a thermoplastic, such as polyvinyl chloride (PVC), and/or other material. For example, the core material may have a relatively low density compared with the other materials of the pumice stone 10, e.g., to reduce the overall weight of the pumice stone 10 and/or reduce the amount of material required to make the finished pumice stone 10. The core 20 may be substantially rigid, semi-rigid, or even flexible, depending upon the flexibility of the other materials of the pumice stone 10. Alternatively, the pumice stone may have a hollow core (not shown), which may also reduce the overall weight and/or conserve materials. Optionally, the core 20 may reduce the overall density of the pumice stone 10 such that the pumice stone 10 may float in water.

To manufacture the pumice stone 10, the components for the abrasive material 12 are selected and mixed together to provide a substantially homogeneous abrasive grit. For example, aluminum oxide and acrylic grains, in a desired ratio, may be mixed together substantially dry to provide a desired blend of abrasive material. The resin for the binder material 14 may be selected and prepared using conventional methods. Once the resin is prepared, the abrasive material may be mixed into the resin.

Once the binder and abrasive material are sufficiently mixed together, the binder-abrasive mixture may be placed in a mold (not shown) having the desired organic shape for the pumice stone 10. The mold may include a first plate (or, optionally, a plurality of plates) including a plurality of recesses (also not shown) corresponding to one or more organic shapes, and the binder-abrasive mixture may be poured or otherwise deposited within each of the recesses. The mold may include a second plate that may mate with the first plate to apply a desired pressure to the mixture within the recesses. Alternatively, a platen or other structure may be provided that may apply the desired pressure against the first plate, and consequently, against the mixture in the recesses.

Optionally, the first plate, second plate (if employed), and/or platen (if employed) may include one or more heating elements for applying heat to the mixture within the recesses, e.g., to enhance, accelerate, and/or complete curing of the binder resin. Alternatively, other known molding procedures may be employed to produce the pumice stone 10. For example, compression molding, injection molding, press molding, or rotational molding apparatus and processes may be used to produce one or a plurality of pumice stones. Once the binder material is substantially cured, the pumice stone(s) may be allowed to cool, if heated, and then may be removed from the mold(s).

Optionally, the pumice stone 10 may include color to enhance the aesthetic appearance of the finished product. For example, as shown by exemplary cross-hatching 22 in FIG. 1, color may be applied to the outer surface of the pumice stone 10. This color may include paint, inks, and/or dyes applied using known methods, e.g., brushing, spraying, air-brushing, and the like. Color may be applied over all of one or more surfaces of the pumice stone 10, e.g., to produce an overall color for the finished product. In addition or alternatively, a pattern of colors, e.g., including multiple color images, may be applied to portions of the surface(s) to create desired effects. For example, in the embodiment shown in FIG. 1, the upper surface 18 may be generally white, and may have rose, pink, brown, and/or other colored splotches applied thereto to simulate the natural color and appearance of a real clam shell.

Alternatively, a color pattern may be applied to the surface(s) of the pumice stone 10 using sublimation, e.g., to transfer a predetermined pattern of colors from a sheet. U.S. Pat. Nos. 6,145,512 and 6,394,099 disclose methods for transferring color to an abrasive surface that may be applied to the methods for making pumice stones described herein. The entire disclosures of these references and any others cited therein are expressly incorporated herein by reference.

In addition or alternatively, pigment (not shown) may be added to the binder-abrasive mixture to provide an overall desired color for the pumice stone 10. For example, one or more liquid dyes, meltable pellets, and/or colored mineral powders may be mixed with at least one of the abrasive material and the binder material. The binder material may have a substantially uniform color therein, e.g., before the abrasive material is mixed with the binder material, or color may be added at the same time or after the abrasive material is mixed with the binder material, e.g., to produce a uniform color or nonuniform color pattern in the pumice stone 10.

In another embodiment, shown in FIG. 1B, a pumice stone 10′ may be formed in layers 11′ that are applied successively to one another to produce the finished product. For example, a first layer 11a′ of binder-abrasive mixture having a first abrasive grit may be placed within a mold (not shown), e.g., defining an upper (or first) surface 18′ of the pumice stone 10.′ A second layer 11b′ of binder-abrasive mixture having a second abrasive grit may then be placed over the first layer 11a,′ thereby defining a lower (or second) surface 16′ of the pumice stone 10.′ The layers 11′ may have different thicknesses, e.g., between about 1/32 inch (0.5 mm) to about one inch (25 mm), or between about ⅛ inch (4 mm) and ¾ inch (18 mm).

The first and second layers 11a,′ 11b′ may be cured simultaneously within the mold, e.g., using similar procedures to those described elsewhere herein. Alternatively, the first layer 11a′ may be partially or completely cured and, thereafter, the second layer 11b′ may be added. The second layer 11b′ may then be cured, along with the first layer 11a′ if the first layer 11a′ has not already been completely cured.

In another embodiment, shown in FIG. 1C, a pumice stone 10″ may be provided that includes an image 22″ embedded beneath a first substantially transparent or translucent layer 11a.″ As explained above, the abrasive material may include substantially transparent or translucent materials, e.g., aluminum oxide, acrylic, and/or glass, and a binder material may be selected that is also substantially transparent or translucent.

Similar to the previous embodiment, a binder-abrasive mixture may be applied within a mold (not shown) to provide the first layer 11a″ (defining to a first surface 18″ of the finished pumice stone. For example, a substantially uniform thickness of the binder-abrasive mixture may be placed in the mold to provide a uniform thickness through which the image 22″ appears. The image 22″ may be applied to the first layer 11a,″ for example, by placing a sheet 24″ having a desired image thereon against the inner surface 13″ of the first layer 11a″ such that the image 22″ is oriented towards the upper surface 18.″

The sheet 24″ may be a sheet of paper, fabric, and the like, e.g., including a colored and/or decorative pattern on at least one surface (the surface oriented towards the first layer 11a.″. he sheet 24″ may be attached to the first layer 11a″ using an adhesive (not shown), by applying heat to at least partially melt the first layer 11a,″ and/or other known methods. The first layer 11a″ may be cured before or after the sheet 24″ is applied. The materials of the first layer 11a″ are preferably selected such that the first layer 11a″ remains substantially transparent or translucent after curing, e.g., without discoloring and/or becoming opaque, to allow the image 22″ to be seen therethrough.

A second layer 11b″ including another binder-abrasive mixture (which may have the same or a different abrasive grit than the first layer 11a″) may be applied to the sheet 24″ and cured, similar to the previous embodiments. Similar to the first layer 11a,″ the second layer 11b″ may be bonded to the sheet 24″ using an adhesive, heat and/or pressure, and the like. Alternatively, the sheet 24″ may be placed between the first and second layers 11a,″ 11b,″ and the first and second layers 11a,″ 11b″ may be cured simultaneously thereafter, as long as the material of the sheet 24″ is sufficiently durable to survive the curing process and/or without damaging the image 22,″ particularly if the process includes applying heat and/or pressure. Processes for bonding sheets with images thereon between layers of transparent or translucent material are disclosed in U.S. Pat. Nos. 6,145,512 and 6,394,099, incorporated by reference above.

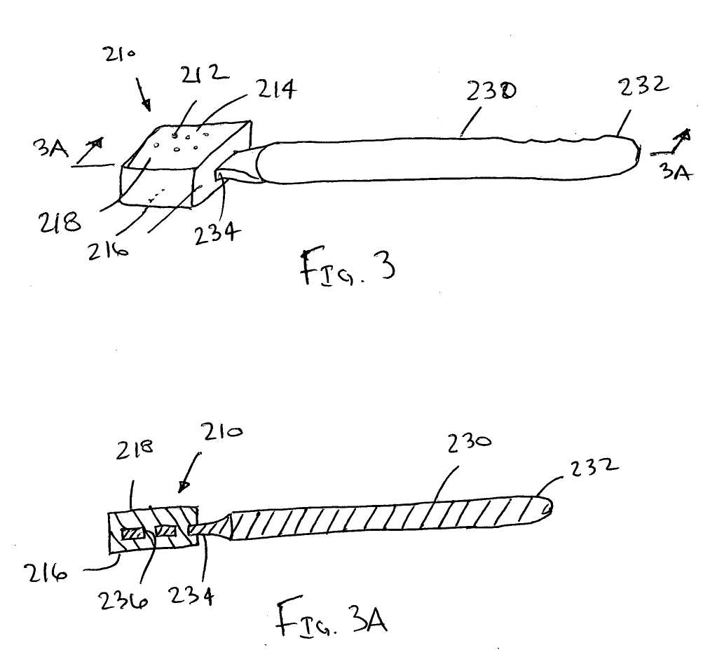

Turning to FIG. 2, another embodiment of a pumice stone 110 is shown that includes abrasive material 112 mixed with binder material 114 and shaped into a desired three-dimensional shape, similar to the previous embodiments. Similar to the previous embodiments, the pumice stone 110 may include one or more blends of abrasive material 112 having desired abrasive grit characteristics. In one embodiment, the abrasive material 112 and/or binder material 114 may be substantially transparent or translucent, e.g., to enhance the appearance if color is added to the pumice stone 110. For example, dyes, powders, meltable color elements may be added to the abrasive material 112 and/or binder material 114 before they are mixed and/or a color or decorative pattern may be applied to the outer surfaces, such as upper surface 118 and/or lower surface 116.

Unlike the previous embodiments, the pumice stone 110 includes one or more inlaid elements 122 integrally formed into the pumice stone 110. For example, the inlaid elements 122 may provide a color and/or decorative pattern on the upper surface 118, as shown. Optionally, one or more similar or different patterns may be provided on additional surfaces, e.g., the lower surface 116. As shown, an arrangement of flowers are provided in the upper surface 118, although other images or other patterns may be provided.

Turning to FIG. 2A, to make the pumice stone 110, a mold may be provided that includes one or more plates, such as plate 90 that includes a cavity 92. The plate 90 may be formed from plaster, metal, or other known materials, and may include heating elements (not shown) if the pumice stone 110 is heated during the process to cure the binder material(s). As shown, the cavity 92 may include one or more interior walls 94 partitioning the cavity 92 into two or more regions 96. As shown, the interior wall(s) 94 may not extend the full height of the mold 90. Thus, the interior region(s) 96 may communicate with the rest of the cavity 92, e.g., when another plate or a platen (not shown) are placed against the plate 90 to seal the cavity 92, e.g., during curing.

Abrasive material 112 may be mixed with binder material 114, and the binder-abrasive mixture may be placed within the cavity 92. In particular, as best seen in FIG. 2A, a first binder-abrasive mixture 124a may be placed within the interior region(s) 96, e.g., up to the height of the interior wall(s) 94. Thereafter, a second binder-abrasive mixture 124b may be added to fill the rest of the cavity 92. Optionally, if the cavity 92 is divided into multiple regions 96, a different binder-abrasive mixture may be placed in two or more of the regions (not shown).

For example, the first binder-abrasive mixture 124a may include a first color (e.g., dyes, etc., as described above), while the second (or additional) binder-abrasive mixture 124b may include a second color. Once the cavity 92 is sufficiently filled, the plate 90 may be covered with a platen or another plate filled with one or more binder-abrasive mixtures (not shown), and the binder-abrasive mixtures 124 may be cured, e.g., using pressure and/or heat, similar to the previous embodiments. Once the binder material is cured, the pumice stone 110 may be removed from the cavity 92.

Because the first and second binder-abrasive mixtures 124 are cured simultaneously, they may bond substantially to one another such that they provide an integral pumice stone 110, as shown in FIG. 2. Because of the different color and/or materials used for the inlaid elements 122, the aesthetic appearance of the pumice stone 110 may be substantially enhanced. If it is desired to provide inlaid elements on the lower surface 116 of the pumice stone 110, another plate, similar to plate 90 shown in FIG. 2A, may also be filled with one or more binder-abrasive mixtures and mated with plate 90, as is known in the art.

Optionally, different abrasive grits may be provided on different surfaces of the pumice stone 110, similar to the previous embodiments described herein. In addition or alternatively, color and/or decorative patterns may be applied to one or more surfaces of the pumice stone 110, also similar to the previous embodiments described herein.

Alternatively, the pumice stone 110 may be made initially without the inlaid elements 122, i.e., with one or more recesses (not shown) in the upper surface 118. The inlaid elements 122 may be made separately, e.g., using similar procedures to those described herein, and the inlaid elements 122 may be bonded or otherwise attached to the pumice stone 110 within the recess(es), e.g., using adhesives, heat, and/or pressure. Such a method may eliminate the need for special molding plates with interior walls, although the inlaid elements 122 may not be held as strongly to the pumice stone 110 as they would if the inlaid elements 122 were integrally molded into the pumice stone 110.

Turning to FIGS. 3 and 3A, yet another embodiment of a pumice stone 210 is provided that includes abrasive material 212 and binder material 214, similar to the previous embodiments. In addition, the pumice stone 210 includes a handle member 230 attached thereto, preferably bonded into the pumice stone 210. The pumice stone 210 includes first and second surfaces 216, 218, which may have the same or different abrasive grits, similar to other embodiments described elsewhere herein. Optionally, the pumice stone 210 may also include a color and/or decorative pattern, inlaid elements, and the like (not shown), also similar to other embodiments described herein.

Generally, the handle member 230 includes a first end 232 and a second end 234. The first end 232 may include a contoured shape to facilitate manipulation by a user, i.e., to provide a handle. The second end 234 is preferably embedded within the pumice stone 210, e.g., before or while the binder material 214 is being cured. The handle member 230 may be formed from a variety of materials, e.g., plastic, wood, metal, and the like. If the handle member 230 is embedded within the pumice stone 210 before the binder material 214 is completely cured, the material should be resistant to any heat and/or pressure to which the pumice stone 210 is subjected during curing.

Optionally, as shown in FIG. 3A, the second end 234 of the handle member 230 may be flat and/or may include one or more holes 236 therethrough. These features may enhance attachment of the pumice stone 210 to the handle member 230 to increase the durability of the finished product.

The handle member 230 may be made using known methods, e.g., molding, machining, milling, and the like. Thereafter, the handle member 230 may be attached to the pumice stone 210. For example, a mold (not shown) may be provided including a cavity having a desired configuration for the pumice stone, e.g., including one or more plates, similar to the methods described elsewhere herein. The mold may include an aperture communicating with the cavity, allowing the second end 234 of the handle member 230 to be disposed within the cavity. One or more binder-abrasive mixtures may be poured, depositing, or otherwise placed in the mold, similar to the previous embodiments, e.g., such that the mixtures completely surround the second end 234 of the handle member 230. If the second end 234 of the handle member 230 includes one or more holes 236 therethrough, the binder-abrasive mixture(s) may penetrate through the hole(s) 236, as shown in FIG. 3A. Thereafter, the binder-abrasive mixture(s) may be cured, e.g., using methods similar to those described elsewhere herein. If desired, color, inlaid elements, and the like (not shown) may be applied to the pumice stone 210 after being cured and removed from the mold. Optionally, the handle member 230 may also be painted, covered, or otherwise treated to provide a desired finish, e.g., to complement the design of the pumice stone 210.

In additional embodiments, pumice stones may also be made that include or are made entirely from “natural” materials. For example, shells, e.g., walnut shells, and/or pits, e.g., apricot, nectarine, and/or peach pits, may be ground into a desired consistency to provide an abrasive material. Linseed oil, rapeseed oil, and the like may be used as a binder material. The abrasive and binder materials may be mixed together and then placed within a mold, and allowed sufficient time for the binder material to cure. Optionally, heat and/or pressure may be used to enhance or accelerate curing, although linseed oil may cure under substantially ambient conditions if given sufficient time, e.g., hours or even days. Alternatively, the abrasive material may be placed in the mold dry, and the binder material may be poured into the mold over the abrasive material, although this may result in nonhomogeneous abrasiveness of the pumice stone, e.g., if the binder material settles or does not penetrate uniformly through the abrasive material.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling the spirit and scope of the appended claims.

I claim:

1. A pumice stone, comprising:
abrasive material comprising a blend of substantially transparent or translucent abrasives;
binder material to hold the abrasive material in a predetermined three-dimensional shape; and
pigment applied to at least one of the abrasive material and the binder material to provide a desired decorative pattern.

2. The pumice stone of claim 1, wherein the predetermined shape is an organic shape.

3. The pumice stone of claim 1, further comprising a hollow core surrounded by the abrasive and binder materials.

4. The pumice stone of claim 1, further comprising core material surrounded by the abrasive and binder materials.

5. The pumice stone of claim 1, wherein the predetermined shape comprises first and second exposed surfaces, and wherein the blend of the abrasive material provides different grits on the first and second exposed surfaces.

6. The pumice stone of claim 1, wherein the binder material comprises a polymer.

7. The pumice stone of claim 6, wherein the abrasive material comprises a blend of abrasives comprising at least two of aluminum oxide, plastic, and glass.

8. The pumice stone of claim 1, wherein the predetermined shape comprises one or more exposed surfaces, and wherein the pigment is applied to the one or more exposed surfaces to provide the desired decorative pattern.

9. The pumice stone of claim 1, wherein the pigment is embedded within the pumice stone.

10. The pumice stone of claim 9, wherein the pigment comprises at least one of a dye, a colored mineral powder, and a meltable pigment.

11. The pumice stone of claim 1, further comprising a handle member having first and second ends, and wherein the abrasive material, binder material, and pigment are provided only on the first end of the handle member.

12. A pumice stone, comprising:
a blend of abrasive material comprising two or more abrasives selected from the group consisting of aluminum oxide, natural pumice, glass, and plastic;
binder material to hold the blend of abrasive material in a predetermined three-dimensional shape; and
pigment to provide a predetermined aesthetic finish to the pumice stone.

13. A pumice stone, comprising:
abrasive material comprising at least one of nut shells and fruit pits; and
a binder material to hold the abrasive material in a predetermined three-dimensional shape.

14. The pumice stone of claim 13, wherein the binder material comprises at least one of linseed oil and rapeseed oil.

15. A pumice stone, comprising abrasive material, and binder material holding the abrasive material in a predetermined three-dimensional organic shape having a desired aesthetic appearance.

16. A pumice stone, comprising:
a first layer including a mixture of abrasive material and binder material having a first abrasive grit; and
a second layer including a mixture of abrasive material and binder material having a second abrasive grit, the second layer being bonded to the first layer.

17. The pumice stone of claim 16, further comprising pigment applied to at least one of the first and second layers to provide a desired decorative pattern.

18. The pumice stone of claim 17, the first and second layers defining one or more exposed surfaces, and wherein the pigment is applied to at least one of the one or more exposed surfaces to provide the desired decorative pattern.

19. The pumice stone of claim 17, wherein the pigment is embedded within at least one of the first and second layers.

20. The pumice stone of claim 17, wherein at least one of the first and second layers is substantially transparent or translucent.

21. The pumice stone of claim 16, wherein the first and second layers are molded into a predetermined three-dimensional organic shape.

22. The pumice stone of claim 16, wherein the abrasive material of at least one of the first and second layers comprises a blend of abrasives comprising at least two of aluminum oxide, plastic, and glass.

23. The pumice stone of claim 16, wherein the first layer is inset at least partially within the second layer.

24. A method for making a pumice stone, comprising:
mixing two or more different abrasives into a blend of abrasive material having a desired abrasive grit;
mixing the blend of abrasive material with binder material; and
curing the binder material to form a predetermined three-dimensional shape.

25. The method of claim 24, wherein the blend of abrasive material and the binder material are substantially transparent or translucent before the binder material is cured, and wherein the binder material is cured without substantially increasing the opacity of the blend of abrasive material and the binder material.

26. The method of claim 24, further comprising adding pigment to at least one of the blend of abrasive material and the binder material.

27. The method of claim 24, further comprising adding pigment to at least one surface of the pumice stone after the binder material is cured.

28. A method for making a pumice stone, comprising:
placing a first layer comprising a first mixture of abrasive material and binder material in a mold;
placing a second layer comprising a second mixture of abrasive material and binder material in the mold, the second layer having at least one of a different pigment and a different abrasive grit than the first layer; and
curing the binder material of the first and second layers to form a three-dimensional pumice stone.

29. The method of claim 28, further comprising:
blending two or more abrasives into a first blend having a first abrasive grit;
mixing the first blend with binder material to create the first mixture;
blending two or more abrasives into a second blend having a second abrasive grit different than the first abrasive grit; and
mixing the second blend with binder material to create the second mixture.

30. The method of claim 29, wherein the first and second layers are placed within the mold such that the first layer defines a first exposed surface of the pumice stone, and the second layer defines a second exposed surface of the pumice stone.

31. The method of claim 28, further comprising adding pigment to at least one of the first and second layers.

32. The method of claim 28, wherein the mold comprises one or more interior walls dividing the mold into different regions corresponding to a first surface of the pumice stone, wherein the first layer is placed within at least one region defined by the one or more interior walls, and wherein the second layer is applied over the first layer such that the second layer extends into at least one other region defined by the one or more interior walls.

33. The method of claim 32, wherein the first layer and the second layer comprise different pigments.

34. The method of claim 33, further comprising removing the pumice stone from the mold to expose the first surface, the first and second layers comprising different color inlaid elements in the first surface.
